(19) United States
(12) Patent Application Publication
(10) Pub. No.: US 2016/0023131 A1
(43) Pub. Date: Jan. 28, 2016

(54) METHOD AND APPARATUS FOR REMOVAL OF SURFACE SCUM

(71) Applicant: FINNCHAIN OY, Rauma (FI)

(72) Inventor: Kimmo Kosunen, Uunsikaupunki (FI)

(21) Appl. No.: 14/773,994

(22) PCT Filed: Mar. 19, 2014
(86) PCT No.: PCT/FI2014/050202

§ 371 Date: Sep. 9, 2015

(30) Foreign Application Priority Data
Apr. 5, 2013 (FI) 20135330

(51) Int. Cl. B01D 21/24; B01D 21/20; C02F 1/40; B01D 21/00

(52) U.S. Cl. CPC B01D 21/2438; B01D 21/0027; B01D 21/20; C02F 1/40

(57) ABSTRACT

A method for removing surface scum in a processing space. The surface scum is collected from a liquid surface with a surface scraper. The surface scraper includes at least one rotating surface scraper and a surface scum remover arranged above the liquid surface and including at least one outlet. The surface scum is guided to the outlet with a guide part arranged at an end of the surface scraper and passing over the outlet while passing along guide surfaces extending above the liquid surface. A closer arranged at a front edge of the surface scum remover is opened and closed. The closer is opened and closed before the guide part of the surface scraper enters the point of the front edge of the surface scum remover. The surface scum is guided to the outlet opening of the surface scum remover utilizing surface liquid when the closer is opened.

The invention relates to a method and an apparatus for removal of surface scum according to the preambles of the independent claims related thereto. The invention is meant to be utilized particularly with an apparatus in a circular processing space, such as a in a clarification tank or the like.

Circular clarification tanks have a long history of service with quite traditional engineering solutions. Hence, first of all, the clarification tank generally has its floor sloping towards its center, whereby a bottom sludge draining channel is located at the center of a clarification tank. The mechanical processing means for their part, being employed in traditional clarification tanks of the foregoing type, are constructed e.g. by providing a clarification tank with one or more surface scrapers, rotating around the center of Said clarification tank and being connected, e.g. by way of rigid shafts, to a bottom scraper for working the latter in synchronization with the surface scraper.

In particular, the removal of surface scum in clarification tanks has been conventionally performed by using a scraper part that exists at an end of a surface scraper and that rotates in an essentially vertical plane, which makes possible rotating movement of the surface scraper in a same level in a direction of height of the processing space. The purpose of the scraper part is to draw surface scum together with escort water along an escort chute of a surface scraper arrangement, i.e. a so-called scum box, reaching above the water surface; so that it can be removed to an outlet opening present in the the scum box. However, the scraper parts of currently available surface scrapers have involved operational problems, resulting occasionally even from ordinary liquid tank surface level fluctuation. The reason for this is that, as the liquid level falls below a certain limit, the surface scum builds up on the escort chute because the scraper part is not able to collect a sufficient quantity of escort water along with the surface scum for carrying it to the outlet opening. As a consequence, the surface scum dries, thus forming lumps and building up on the scraper and the scum box structures and further in a discharge pipe system. The above problems are emphasized particularly under cold circumstances due to freezing, in which case the adverse effect of the small quantity of escort water is further emphasized.

It is an objective of the method and the apparatus for removal of surface scum according to the present invention to provide a decisive improvement in terms of the above-described problems and to thereby upgrade substantially the existing prior art. In order to achieve this objective, the method and the apparatus according to the invention are principally characterized by what has been presented in the characterizing parts of the independent claims related thereto.

The most important benefits gained by the method and the apparatus according to the invention notably include the simplicity, working reliability and efficiency of the constructions applicable for the same as well as assembly and operation thereof in practise, which is particularly thanks to the removal of surface scum being carried out in a differing manner, when compared to so called traditional way of thinking, whereby the surface scum is being flushed to the outlet opening of the surface scum removal arrangement by using an adequately large quantity of surface water of the processing space. Thus, by virtue of the invention, first of all, ensuring the efficient and functionally reliable removal of surface scum from a circular processing space, such as a clarification tank, can be ensured, while at the same time minimizing in this respect the overhaul and maintenance demand of the discussed process apparatus. By an adequately strong flushing of the surface scum, the surface scum is not able to get collected in the surface scum removal arrangement, thanks to which it is not able to form lumps, either. This has been carried out by using a closing arrangement, when viewed in the rotating direction of the surface scraper, at a front edge of the surface scum removal arrangement, so that it is being opened and closed essentially before the guide part of the surface scraper enters at the point of the front edge of the surface scum removal arrangement. The invention furthermore enables operation of a block plate of the closing arrangement in a so called self operated manner, so that it is being controlled mechanically by using mutual driving means between the surface scraper and the closing arrangement, which is carried out profitably by co-operation of a counterpart, existing at an end of the surface scraper; and a guide element, being coupled with the block Plate, the guide element getting back to its stand-by position and returning the block plate to its closing position profitably in a gravity operated manner.

Other preferred embodiments for the method and the apparatus according to the invention are presented in the dependent claims related thereto.

The invention will be discussed in detail in the subsequent specification with reference to the accompanying drawings, in which

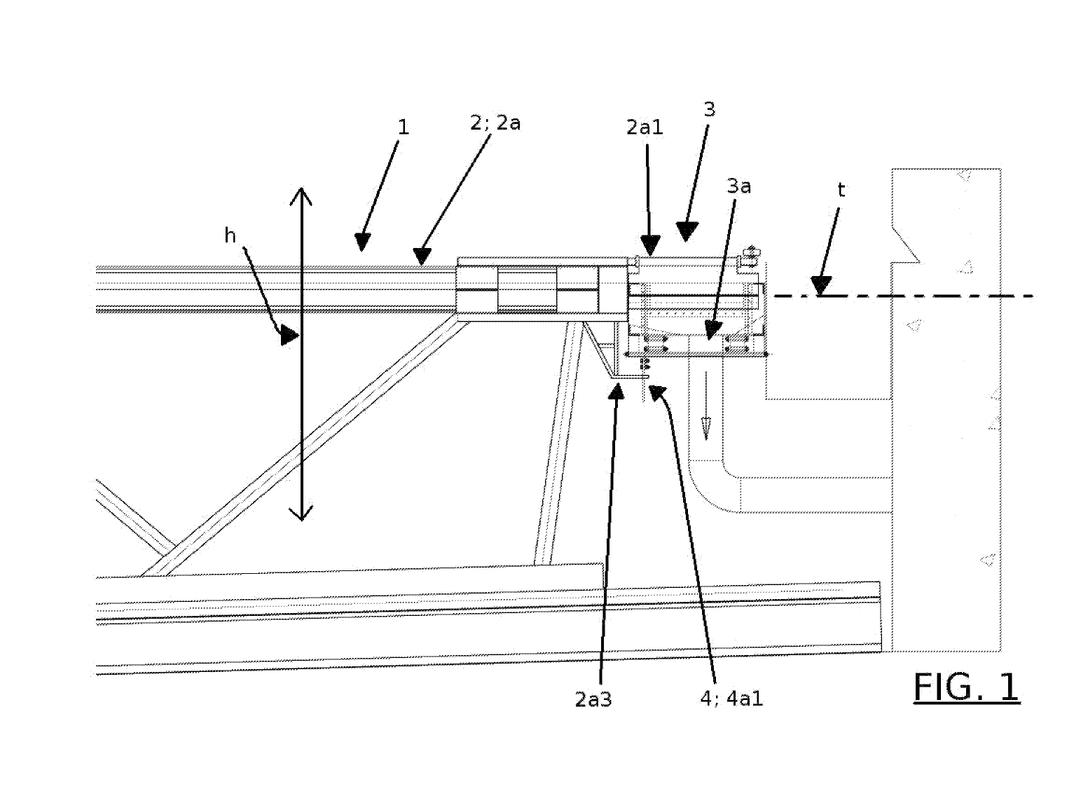

FIG. 1 shows a front view of a head in the surface scraper, when the invention is being utilized in connection with a bottom-surface scraper combination in a circular processing space,

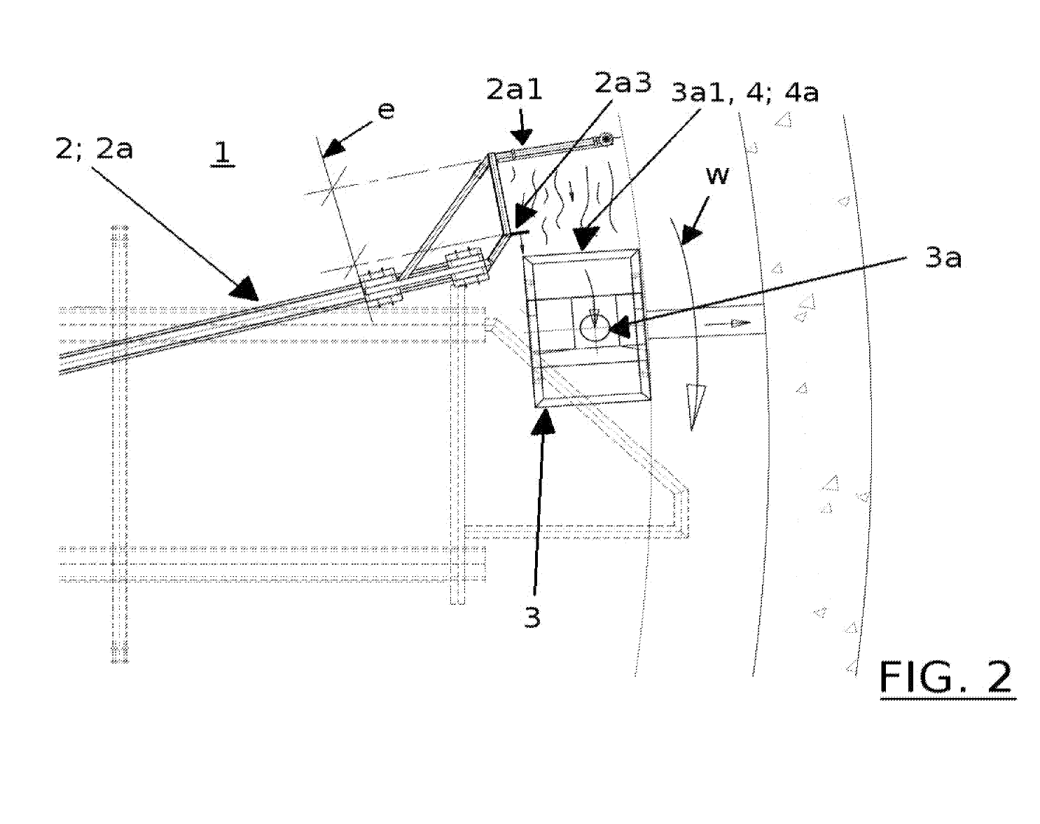

FIG. 2 is shown an implementation corresponding to FIG. 1 as an overhead view, and

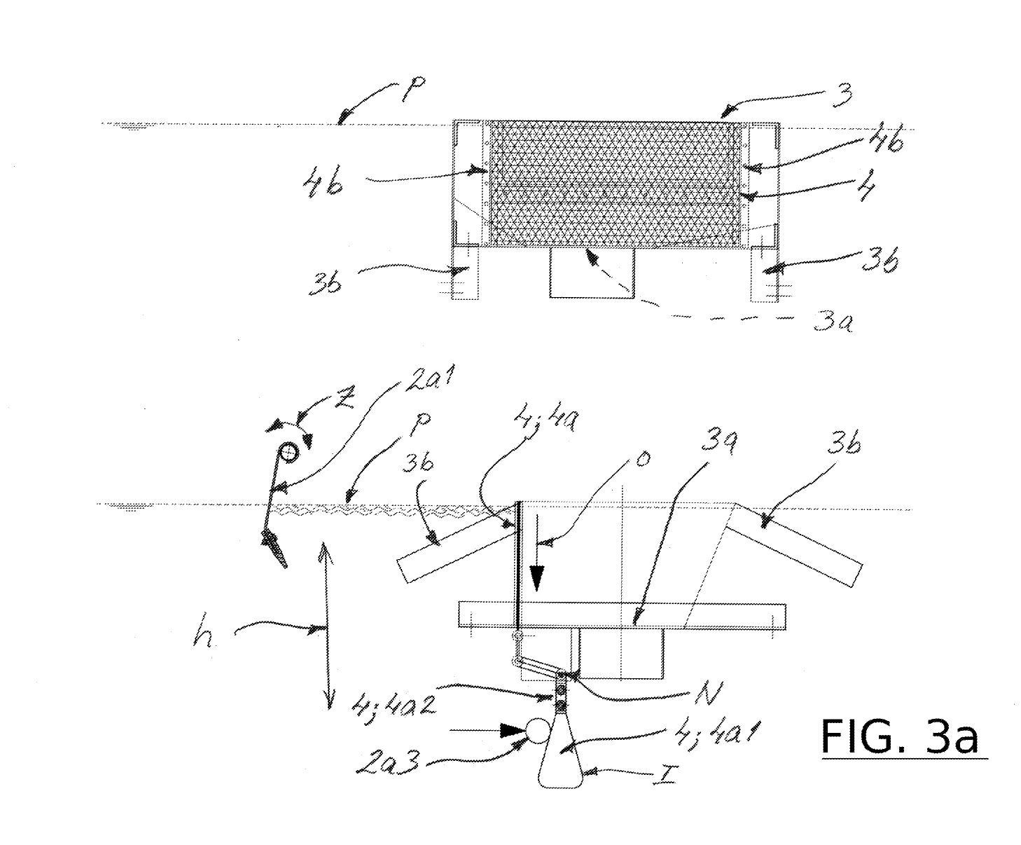

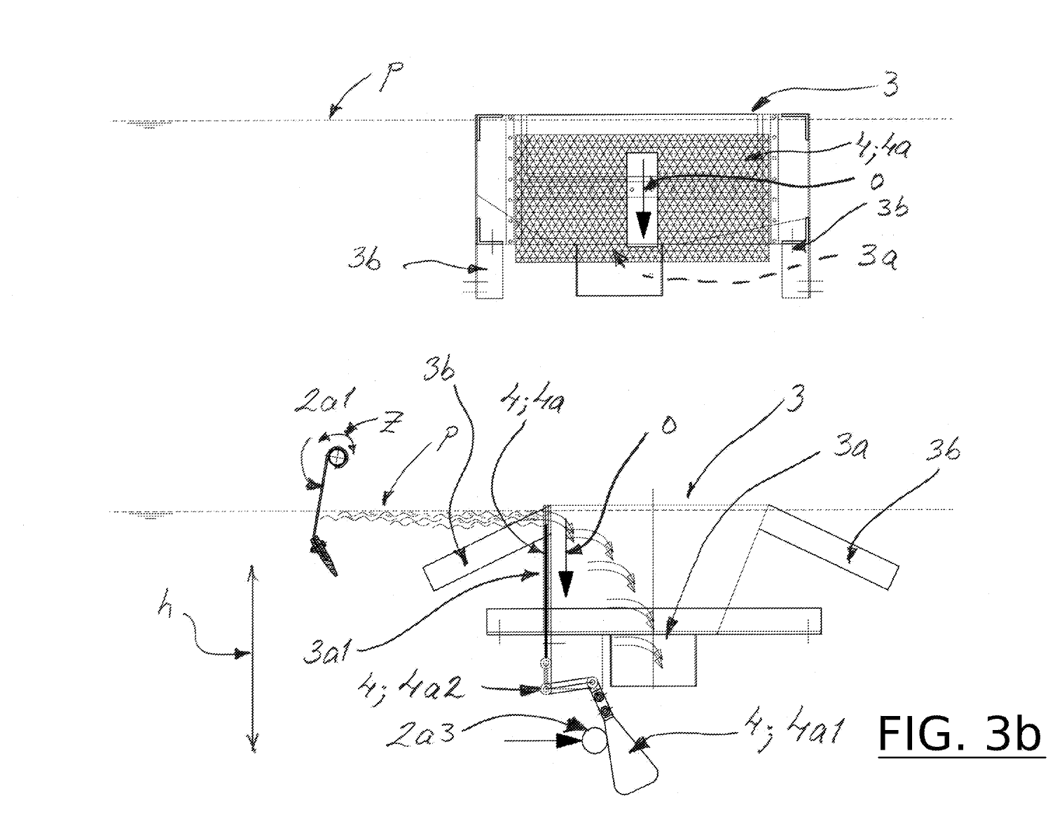

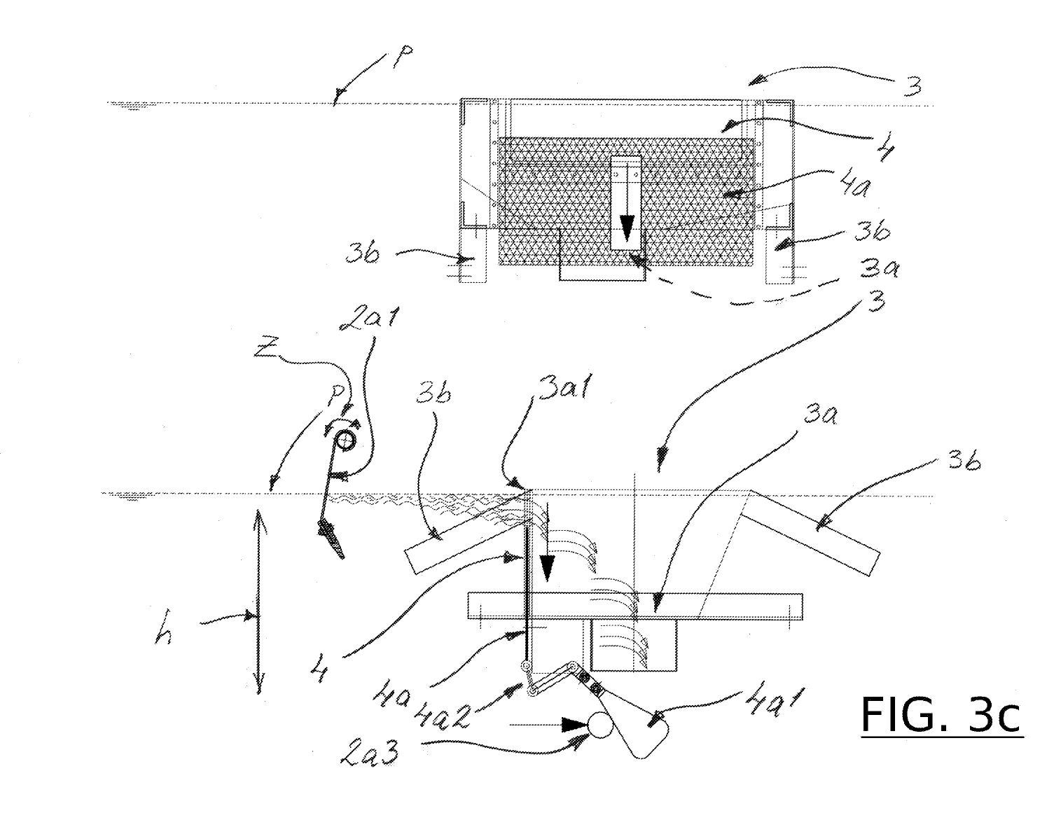

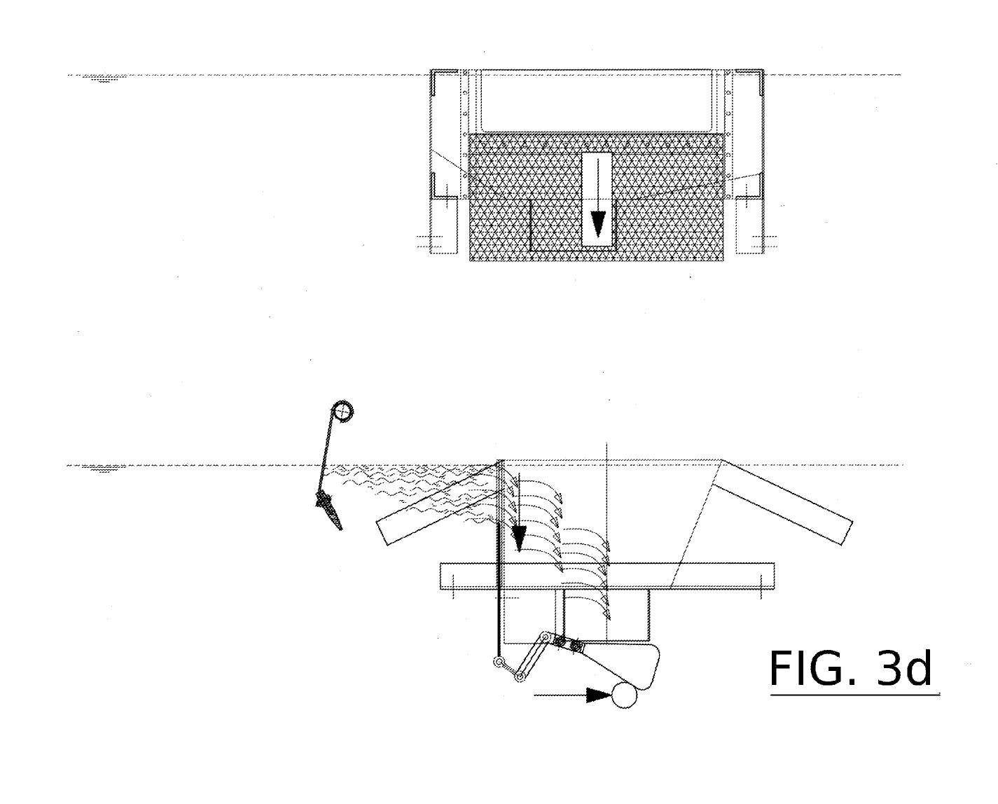

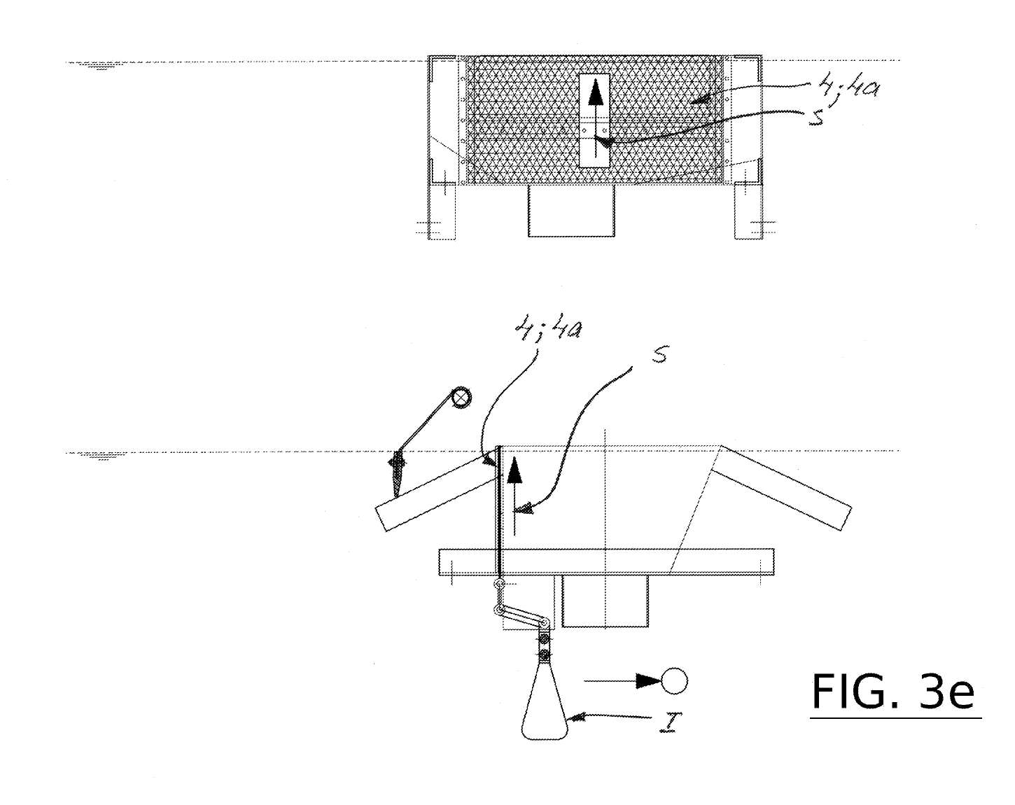

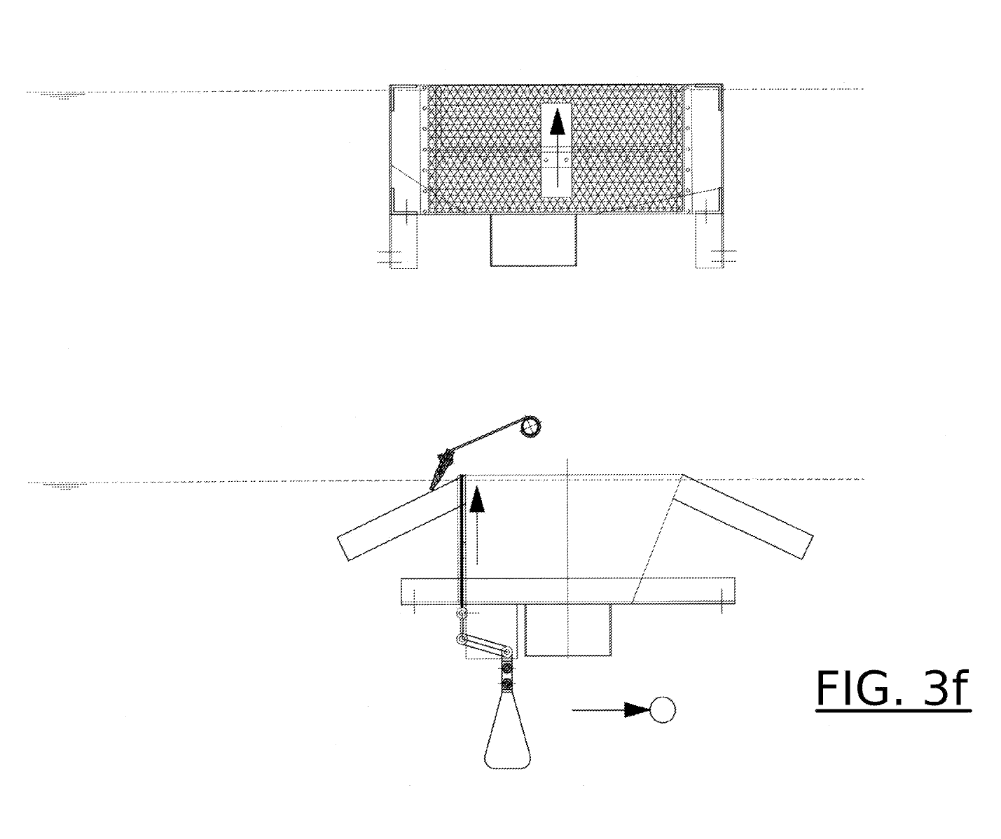

FIGS. 3a-3f show in front and side views the removal of surface scum operating according to the invention in succesive phases, while the surface scraper rotates in the processing space, while the head of the surface scraper moves over the surface scum removal arrangement.

The invention relates first of all to a method for removal of surface scum by means of an apparatus particularly in a circular processing space 1, such as a clarification tank as shown e.g. in FIGS. 1a and 2 or like, wherein the apparatus comprises a surface scraper arrangement 2, by means of which surface scum on a surface of liquid in the processing space is being collected by one or more surface scrapers 2a that rotate w in the processing space, and a surface scum removal arrangement 3 that exists essentially above the liquid surface p of the processing space and by means of which the surface scum is being removed through one or more outlet openings 3a belonging thereto. The surface scum is being guided to the outlet openings by a guide part 2a1 that exists at an end of the surface scraper 2a and that passes over the outlet openings 3a while passing along guide surfaces 3b reaching above the liquid surface. The guide part is advantageously arranged to rotate z in an essentially vertical plane particularly in order to enable a rotating movement w of the surface scraper 2a as shown in FIG. 1 in a same level t, when viewed in a direction of height h of the processing space. The apparatus comprises a closing arrangement 4, by opening o of which the surface scum, being guided to the surface scum removal arrangement 3 by the surface scraper 2a, is being flushed to the outlet opening 3; 3a of the surface scum removal arrangement by using surface water of the processing space.

As an advantageous embodiment of the method according to the invention, the closing arrangement 4, when viewed in the rotating direction w of the surface scraper 2a, at a front edge 3a1 of the surface scum removal arrangement 3 is being opened o and closed s essentially before the guide part 2a; 2a1 of the surface scraper enters the point of the front edge 3a1 of the surface scum removal arrangement.

Furthermore as an advantageous embodiment Of the method according to the invention, operation of the closing arrangement 4, such as a block plate 4a being arranged movable essentially in the direction of height h, is being controlled mechanically by using mutual driving means between the surface scraper 2a and the closing arrangement 4, such as by a co-operation as shown in FIGS. 1, 3a-3d of a counterpart 2a3, existing at an end of the surface scraper 2a, and a guide element 4a1, being coupled with the block plate 4a, the guide element getting back to its stand-by position I and returning the block plate 4a to its closing position advantageously in a gravity operated manner.

Furthermore as an advantageous embodiment of the method, an opening advance timing of the closing arrangement 4 is being set by adjusting a distance e of the counterpart 2a3 at the end of the surface scraper suitable in respect with the guide part 2a1 of the surface scraper.

Furthermore as an advantageous embodiment of the method, the closing arrangement's 4 opening movement, such as its duration and movement speed in the direction of height h, is being regulated by changing a shape or length of the guide element 4a1 or in a corresponding manner.

The invention relates on the other hand also to an apparatus for removal of surface scum particularly from a circular processing space 1, such as a clarification tank as shown in FIGS. 1 and 2 or like. The apparatus comprises at least a surface scraper arrangement 2 for collecting surface scum on a surface of liquid in the processing space by one or more surface Scrapers 2a rotating w in the processing space and a surface scum removal arrangement 3 existing essentially above the liquid surface p of the processing space for-removal of the surface scum through one or more outlet openings 3a belonging thereto. The surface scum is guided to the outlet openings by a guide part 2a1 existing at an end of the surface scraper 2a and that passes over the outlet openings 3a while passing along guide surfaces 3b reaching above the liquid surface. The guide part is profitably arranged to rotate z in an essentially vertical plane particularly in order to enable a rotating movement w of the surface scraper 2a in a same level t, when viewed in a direction of height h of the processing space. The apparatus comprises a closing-arrangement 4 that is arranged first of all to be opened o by driving means in order to flush the surface scum, guided to the surface scum removal arrangement 3 by the surface scraper 2a, to the outlet opening 3; 3a of the surface scum removal arrangement by using surface water of the processing space on the principle as shown in FIGS. 3a-3d, and on the other hand to be closed after the above described flushing phase as shown in FIGS. 3e and 3f.

As an advantageous embodiment of the apparatus according to the invention, the closing arrangement 4 arranged, when viewed in the rotational direction w of the Surface scraper 2a, a front edge 3a1 of the surface scum removal arrangement 3 comprises a block plate 4a or like that is arranged movable essentially in the direction of height h by a slide rail arrangement 4b or in a corresponding manner.

As a furthermore advantageous embodiment of the apparatus according to the invention, the opening and closing movements o, s of the closing arrangement 4 are arranged mechanically by using mutual driving means between the surface scraper 2a and the closing arrangement 4, such as by a co-operation as shown in FIGS. 3a-3f of a counterpart 2a3, existing at an end of the surface scraper 2a, and a guide element 4a1, being coupled with the block plate 4a.

Furthermore as an advantageous embodiment of the apparatus according to the invention, the guide element 4a1 is arranged to get back to its stand-by position I and to return the block plate 4a to its closing position in a gravity operated manner.

The driving means being carried out according to FIGS. 3a-3f comprise a guide element 4a1, the form of which being designed for each operating situation, and the guide element being coupled with the block plate 4a by a jointed arm assembly 4a2. The guide element is articulated N by its upper end in a rotating manner to a fixed structure in the surface scum removal arrangement; in which case as shown in FIGS. 3b-3d, when rotating by influence of the counterpart 2a3, moves o the block plate 4a in the direction of height h thus opening the front edge 3a1 of the surface scum removal arrangement. When the counterpart 2a3 has passed the guide element 4a1, the guide element gets back to a vertical position by gravity, while I at the same time, moving s the block plate 4a according to FIGS. 3e and 3f back to its position that closes the front edge of the surface scum removal arrangement.

Furthermore as an advantageous embodiment of the apparatus according to the invention, the closing arrangement 4 is adjustable for the part of its opening advance timing by making the distance e of the counterpart 2a3 at the end of the surface scraper in respect with the guide part 2a1 of the surface scraper adjustable and/or for the part of the closing arrangement's 4 opening movement, such as regarding its duration and movement speed in the direction of height h, by changing a shape or length of the guide element 4a1 or in a corresponding manner.

It is to be understood that the invention is not limited to the embodiments illustrated or described above, but it lends itself to variations within the basic inventive concept according to any given conditions and application demands. Thus, first of all, it is clear that, depending on the size of a process tank; it is possible to employ one or several surface scrapers designed according to the invention, wherein surface scum scraping parts are made from any of a most diverse range of manufacturing materials, by using a most diverse range of manufacturing techniques, and having been assembled by a range of optional methods highly diverse in technical sense. Respectively, the mechanical processing means utilized in the invention can be implemented in a highly diverse existing ways in terms of their mobility in a process space, although the embodiment shown e.g. in FIG. 2, wherein the movement of a surface scraper is designed to be effected by a chain running along the edges of a clarification tank, is preferred for practical reasons, especially because the chain is capable of being manufactured from plastics, which is another factor contributing to the optimally low overhaul and maintenance demand for an apparatus of the invention.

1. A method for removal of surface scum utilizing an apparatus in a processing space, the method comprising:
collecting surface scum on a surface of liquid in the processing space with a surface scraper arrangement, wherein the surface scraper arrangement comprises at least one surface scraper that rotates in the processing space, and a surface scum removal arrangement arranged above the liquid surface of the processing space and and including at least one outlet opening configured to remove the surface scum;
guiding the surface scum is to the outlet openings with a guide part arranged at an end of the surface scraper and that passes over the outlet openings while passing along guide surfaces reaching above the liquid surface;
opening and closing a closing arrangement arranged at a front edge of the surface scum removal arrangement with respect to a direction of rotation of the surface scraper, wherein the closing arrangement is opened and closed essentially before the guide part of the surface scraper enters the point of the front edge of the surface scum removal arrangement; and
flushing the surface scum, being guided to the surface scum removal arrangement by the surface scraper, to the outlet opening of the surface scum removal arrangement utilizing surface liquid of the processing space, when the closing arrangement is being opened.

2. The method according to claim 1, further comprising:
mechanically controlling operation of the closing arrangement utilizing mutual drivers between the surface scraper and the closing arrangement.

3. The method according to claim 2, wherein the closing arrangement comprises a block plate that is movable essentially in a direction of height, whereby the mutual driver comprises a counterpart arranged at the end of the surface scraper, and a guide element coupled with the block plate, the method further comprising:
driving the guide element back to a stand-by position, while simultaneously returning the block plate to a closing position in a gravity operated manner.

4. The method according to claim 3, further comprising:
setting an opening advance timing of the closing arrangement by adjusting a distance of the counterpart at the end of the surface scraper with respect to the guide part of the surface scraper.

5. The method according to claim 3, further comprising:
regulating the opening movement of the closing arrangement by changing a shape or a length of the guide element.

6. An apparatus for removal of surface scum from a processing space the apparatus comprising:
a surface scraper arrangement configured to collect surface scum on a surface of liquid in the processing space, the surface scraper arrangement comprising at least one surface scraper rotating in the processing space;
a surface scum removal arrangement arranged essentially above the liquid surface of the processing space, the surface scum removal arrangement comprising at least one outlet opening configured to remove surface scum;
a guide part configured to guide the surface scum to the outlet opening, the guide part being arranged at an end of the surface scraper and passing over the outlet openings while passing along guide surfaces extending above the liquid surface;
a closing arrangement arranged at a front edge of the surface scum removal arranged with respect to a rotational direction of the surface scraper, wherein the closing arrangement is arranged before the guide part of the surface scraper enters the point of the front edge of the scraper scum removal arrangement; and
a driver configured open the closing arrangement in order to flush the surface scum, guided to the surface scum removal arrangement by the surface scraper, to the outlet opening of the surface scum removal arrangement by using surface liquid of the processing space, and to close the closing arrangement after the above flushing phase.

7. The apparatus according to claim 6, further comprising:
mutual drivers arranged between the surface scraper and the closing arrangement and configured to mechanically open and close the closing arrangement.

8. The apparatus according to claim 7, wherein the closing arrangement comprises a block plate that is movably arranged essentially in a direction of height, further comprising:
a counterpart arranged at an end of the surface scraper, and
a guide element coupled with the block plat,
wherein cooperation of the counterpart and the guide element operates the drivers.

9. The apparatus according to claim 8, wherein the guide element is configured to return to a stand-by position and to return the block plate to a closing position in a gravity operated manner.

10. The apparatus according to claim 8, wherein the closing arrangement is adjustable for a part of an opening advance timing by making the distance of the counterpart at the end of the surface scraper with respect to the guide part of the surface scraper and/or for the part of the opening movement of the closing arrangement adjustable by changing the shape or length of the guide element.

11. The apparatus according to claim 10, wherein a movement duration and movement speed in a direction of height of the closing arrangement is adjustable.

12. The apparatus according to claim 6, wherein the processing space is circular.

13. The apparatus according to claim 6, wherein the processing space comprises a clarification tank.

14. The apparatus according to claim 6, wherein the guide part is arranged to rotate in an essentially vertical plane particularly in order to enable a rotating movement of the surface scraper in a same level with respect to a direction of height of the processing space.

15. The apparatus according to claim 8, further comprising:
a slide rail arrangement configured to movably arrange the a block plate essentially in the a direction of height.

16. The method according to claim 1, further comprising:
arranging the guide part to rotate in an essentially vertical plane particularly in order to enable a rotating movement of the surface scraper in a same level with respect to a direction of height of the processing space.

17. The method according to claim 5, wherein a duration of movement and a movement speed of the closing arrangement are regulated.
